(19) United States
(12) Patent Application Publication
(10) Pub. No.: US 2025/0103425 A1
(43) Pub. Date: Mar. 27, 2025

(54) CYCLIC REDUNDANCY CHECK COMPARISON FOR ERROR DETECTION

(71) Applicant: Micron Technology, Inc., Boise, ID (US)

(72) Inventors: Andreas Schneider, Gernlinden (DE); Andrea Sorrentino, München (DE); Peter Mayer, Neubiberg (DE); Rethin Raj, Augsburg (DE); Ankur Gupta, München (DE); Marcos Alvarez Gonzalez, München (DE)

(21) Appl. No.: 18/774,412

(22) Filed: Jul. 16, 2024

Related U.S. Application Data
(60) Provisional application No. 63/585,768, filed on Sep. 27, 2023.

(51) Int. Cl. G06F 11/10

(52) U.S. Cl. CPC G06F 11/1004

(57) ABSTRACT

Methods, systems, and devices for cyclic redundancy check (CRC) comparison for error detection are described. A host system may determine an error cause associated with writing data to or reading data from a memory system. For writing data, the host system may transmit data and a CRC value to the memory system. The memory system may calculate another CRC value and indicate an error and the calculated CRC value based on the received and calculated CRC values being different. The host system may compare the calculated CRC value and the originally transmitted CRC value to determine an error cause. For reading data, the host system may receive data and an associated CRC value from the memory system, calculate a CRC value using the received data, and determine an error cause based on a comparison of the received CRC value, the calculated CRC, and an expected CRC value.

### CROSS REFERENCE

The present Application for Patent claims priority to U.S. Patent Application No. 63/585,768 by Andreas Schneider et al., entitled “CYCLIC REDUNDANCY CHECK COMPARISON FOR ERROR DETECTION,” filed Sep. 27, 2023, which is assigned to the assignee hereof, and which is expressly incorporated by reference in its entirety herein.

### TECHNICAL FIELD

The following relates to one or more systems for memory, including cyclic redundancy check (CRC) comparison for error detection.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports cyclic redundancy check (CRC) comparison for error detection in accordance with examples as disclosed herein.

FIG. 2 shows an example of an architecture that supports CRC comparison for error detection in accordance with examples as disclosed herein.

FIGS. 3 and 4 show examples of systems that support CRC comparison for error detection in accordance with examples as disclosed herein.

FIG. 5 shows a block diagram of a host system that supports CRC comparison for error detection in accordance with examples as disclosed herein.

FIG. 6 shows a block diagram of a memory system that supports CRC comparison for error detection in accordance with examples as disclosed herein.

FIGS. 7 through 9 show flowcharts illustrating a method or methods that support CRC comparison for error detection in accordance with examples as disclosed herein.

### DETAILED DESCRIPTION

Some systems may utilize cyclic redundancy checks (CRCs) to detect errors in data. For example, CRC values may be calculated based on data, and CRC values calculated using the same data may be the same. Thus, a difference in CRC values may indicate an error in the data and that may result from the transmission, storage, or retrieval of the data and/or an error associated with the transmission of a CRC value. For example, a host system may calculate a CRC value associated with data and may transmit the data and the associated CRC value to a memory system. After receiving the data and the CRC value, the memory system may calculate another CRC value using the received data (e.g., before storage of the data, after storage and retrieval of the data). The memory system may compare the memory system-calculated CRC value to the CRC value received from the host system. In the case that the received CRC value and the memory system-calculated CRC value do not match, the memory system may transmit an error flag to the host system indicating an error, which may be referred to as a CRC error. However, while it may be beneficial for the memory system to indicate the detected error to the host system, neither the memory system nor the host system may determine where in the data transmission, storage, or retrieval, or in the CRC transmission, the error may have occurred, which may result in further errors and/or ineffective or inefficient error correction techniques.

In accordance with examples described herein, a memory system and a host system may support determination of one or more causes of a CRC error based on a comparison of CRC values associated with data, which may support the implementation of efficient and effect corrective actions. For example, the host system and the memory system may support determining the cause of errors associated with writing data to the memory system. To support such determination, the memory system may transmit the memory system-calculated CRC value to the host system in addition to the indication of the CRC error. The host system may utilize the CRC value originally transmitted to the memory system and the memory system-calculated CRC value received from the memory system to determine a cause of the error at a more granular level. For example, the originally transmitted CRC value and the memory system-calculated CRC value being different may indicate that the error is associated with at least the transmission, storage, or retrieval of the data. The originally transmitted CRC value and the memory system-calculated CRC value being different may indicate that the error is associated with the transmission of the original CRC value from the host system to the memory system.

Additionally, or alternatively, the host system may support determining the cause of errors associated with reading data from the memory system. For example, the host system may transmit a command to read data from the memory system. In accordance with the command, the memory system may calculate a CRC value associated with the requested data and transmit the data and the CRC value to the host system. The host system may receive the data and the CRC value, and may calculate another CRC value using the received data. The host system may compare the CRC value calculated from the received data to both the CRC value received from the memory system and an expected CRC value (e.g., a CRC value associated with data that the host system expects to receive from the memory system) to determine one or more causes of a CRC error. For example, as described herein, the comparison of the CRC values may indicate whether a CRC error is associated with the transmission of the CRC value by the memory system or associated with the data prior to or after the calculation of the CRC value. By implementing error cause determination techniques described herein, error causes may be determined at a more granular level, which may support relatively more efficient and effective error correction techniques to support improved performance of the memory system, among other benefits.

Features of the disclosure are illustrated and described in the context of systems and architectures. Features of the disclosure are further illustrated and described in the context of block diagrams and flowcharts.

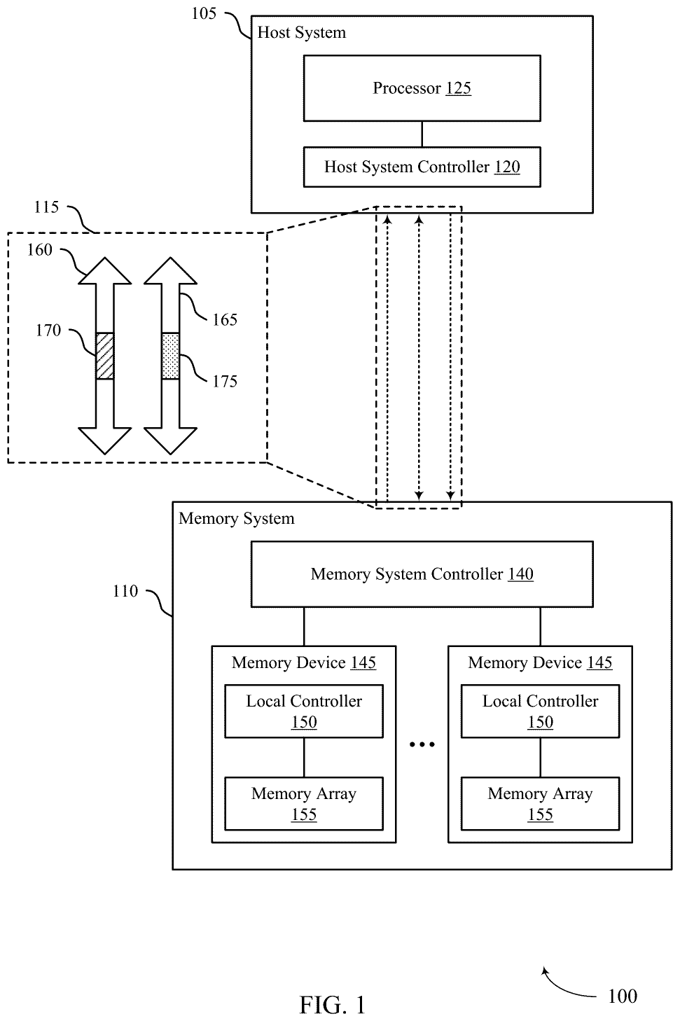

FIG. 1 illustrates an example of a system 100 that supports CRC comparison for error detection in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel 160 (e.g., a DQ channel) may be operable to communicate (e.g., bidirectionally) information (e.g., data 170, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels 165. An EDC channel 165 may be operable to communicate error detection signals, such as one or more CRC values 175, checksums, or parity bits, which may accompany information conveyed over a data channel. In some examples, an EDC channel 165 may be an example of a DQE channel, which may be operable to communicate error detection signals and may be additionally or alternatively operable to communicate one or more data symbols, severity (SEV) information, poison (PSN) information, or a combination thereof.

In accordance with examples described herein, the memory system 110 and the host system 105 may be configured to determine one or more causes of a CRC error based on the comparison of CRC values 175 associated with the data 170, which may support the implementation of efficient and effect corrective actions. The host system 105 may be configured to determine the cause of CRC errors associated with writing data 170 to the memory system 110. For example, the host system 105 may transmit data 170 and an associated CRC value 175 (e.g., via the data channel 160 and EDC channel 165, respectively) to the memory system 110. The memory system 110 may store the data 170 and may calculate another CRC value 175 using the data 170 received from the host system 105 (e.g., the stored data 170). The memory system 110 may compare the CRC value 175 received from the host system 105 (e.g., which may be different than the CRC value 175 originally transmitted by the host system 105, such as based on an error associated with the transmission of the CRC value 175 via the EDC channel 165) and the calculated CRC value 175. In the case that the two CRC values are not the same, the memory system 110 may transmit an indication of a CRC error to the host system 105. Based on the CRC error, the memory system 110 may transmit the calculated CRC value 175 to the host system 105. The host system 105 may compare the CRC value 175 originally transmitted to the memory system 110 and the calculated CRC value 175 received from the memory system 110 to determine a cause of the error at a more granular level. For example, the originally transmitted CRC value 175 and the calculated CRC value 175 being different may indicate that the error is associated with at least the transmission, storage, or retrieval of the data 170. The originally transmitted CRC value 175 and the calculated CRC value 175 being different may indicate that the error is associated with the transmission of the original CRC value 175 via the EDC channel 165.

Additionally, or alternatively, the host system 105 may be configured to determine the cause of errors associated with reading data from the memory system 110. For example, the host system 105 may transmit a command to read data 170 from the memory system 110. In accordance with the command, the memory system 110 may calculate a CRC value 175 associated with the requested data 170 and transmit the data 170 and the CRC value 175 to the host system 105 (e.g., via the data channel 160 and the EDC channel 165, respectively). The host system 105 may receive the data 170 and the calculated CRC value 175 and may calculate another CRC value 175 using the received data 170. The host system 105 may compare the CRC value 175 calculated from the received data 170, the CRC value 175 received from the memory system 110, and an expected CRC value 175 (e.g., a CRC value 175 associated with data 170 the host system 105 expects to receive from the memory system 110) to determine one or more causes of a CRC error. For example, the comparison of the CRC values may indicate whether a CRC error is associated with the transmission of the CRC value by the memory system or associated with the data prior to or after the calculation of the CRC value. By implementing error cause determination techniques described herein, error causes may be determined at a more granular level, which may support relatively more efficient and effective error correction techniques to support improved performance of the memory system, among other benefits.

In addition to applicability in systems as described herein, techniques for error detection utilizing CRC comparisons may be generally implemented to improve the performance (including gaming) of various electronic devices and systems. Some electronic device applications, including gaming and other high-performance applications, may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by improving error detection and correction techniques, which may reduce error occurrence, which may improve memory access speeds, decrease processing or latency times, improve response times, or otherwise improve user experience, among other benefits.

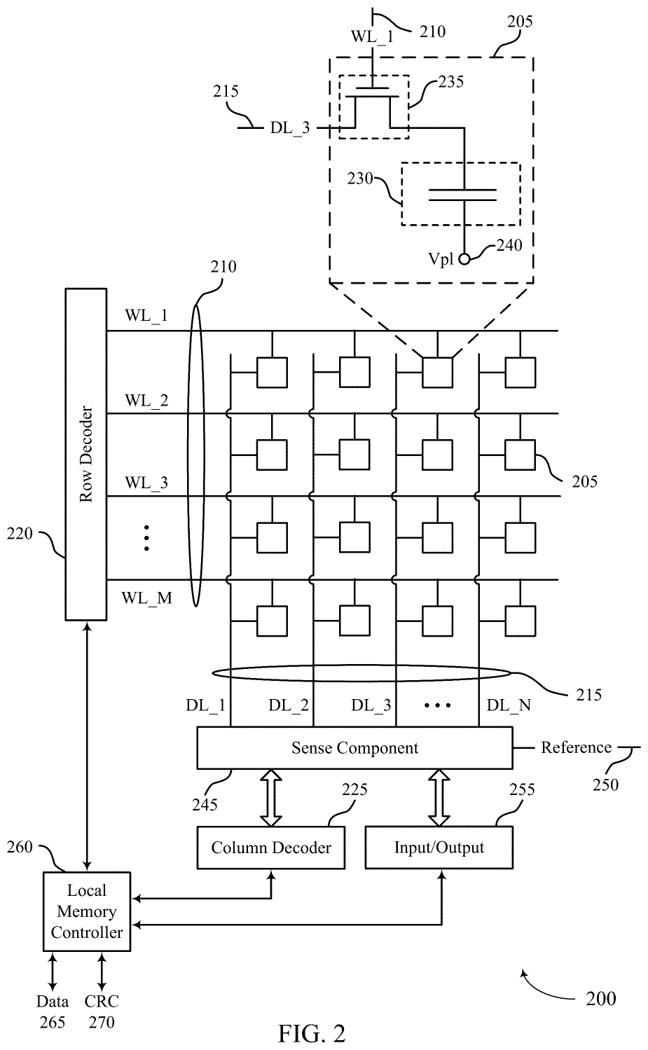

FIG. 2 illustrates an example of an architecture 200 (e.g., a memory architecture) that supports CRC comparison for error detection in accordance with examples as disclosed herein. The architecture 200 may be implemented in a memory system 110 or one or more components thereof (e.g., memory device 145). Aspects of the architecture 200 may be referred to as or implemented in a semiconductor component, such as a memory die.

The architecture 200 includes memory cells 205 that are programmable to store information. In some examples, a memory cell 205 may be operable to store one bit of information at a time (e.g., a logic 0 or a logic 1). In some examples, a memory cell 205 (e.g., a multi-level memory cell) may be operable to store more than one bit of information at a time (e.g., a logic 00, logic 01, logic 10, a logic 11). Memory cells 205 may be arranged in an array, such as in a memory array 155.

In the example of architecture 200, a memory cell 205 may include a storage component, such as capacitor 230, and a selection component 235 (e.g., a cell selection component, a transistor). A capacitor 230 may be a dielectric capacitor or a ferroelectric capacitor. A node of the capacitor 230 may be coupled with a voltage source 240, which may be a cell plate reference voltage, such as Vpl, or may be a ground voltage, such as Vss. A charge stored by a memory cell 205 (e.g., by a capacitor 230) may be representative of a programmed state. Other memory architectures that support the techniques described herein may implement different types or arrangements of storage components and associated circuitry (e.g., with or without a selection component).

The architecture 200 may include various arrangements of access lines, such as word lines 210 and digit lines 215. An access line may be a conductive line that is coupled with a memory cell 205, and may be used to perform access operations on the memory cell 205. Word lines 210 may be referred to as row lines, and digit lines 215 may be referred to as column lines or bit lines, among other nomenclature. Memory cells 205 may be positioned at intersections of access lines, and an intersection may be referred to as an address of a memory cell 205.

In some architectures, a word line 210 may be coupled with a gate of a selection component 235 of a memory cell 205, and may be operable to control (e.g., switch, modulate a conductivity of) the selection component 235. A digit line 215 may be operable to couple a memory cell 205 with a sense component 245. In some architectures, a memory cell 205 (e.g., a capacitor 230) may be coupled with a digit line 215 during portions of an access operation. For example, a word line 210 and a selection component 235 of a memory cell 205 may be operable to couple or isolate a capacitor 230 of the memory cell 205 with a digit line 215.

Operations such as reading and writing may be performed on memory cells 205 by activating (e.g., applying a voltage to) access lines such as a word line 210 or a digit line 215. Accessing the memory cells 205 may be controlled through a row decoder 220, or a column decoder 225, or a combination thereof. For example, a row decoder 220 may receive a row address (e.g., from a local memory controller 260) and activate a word line 210 based on a received row address, and a column decoder 225 may receive a column address and activate a digit line 215 based on a received column address. Selecting or deselecting a memory cell 205 may include activating or deactivating a selection component 235 using a word line 210. For example, a capacitor 230 may be isolated from a digit line 215 when the selection component 235 is deactivated, and the capacitor 230 may be coupled with the digit line 215 when the selection component 235 is activated.

A sense component 245 may be operable to detect a state (e.g., a charge) stored by a capacitor 230 of a memory cell 205 and determine a logic state of the memory cell 205 based on the stored state. A sense component 245 may include one or more sense amplifiers to amplify or otherwise convert a signal resulting from accessing the memory cell 205. The sense component 245 may compare a signal detected from the memory cell 205 with a reference 250 (e.g., a reference voltage). The detected logic state of the memory cell 205 may be provided as an output of the sense component 245 (e.g., via an input/output 255), and may indicate the detected logic state to another component of a memory system 110 that implements the architecture 200.

The local memory controller 260 may control the accessing of memory cells 205 through the various components (e.g., a row decoder 220, a column decoder 225, a sense component 245), and may be an example of or otherwise included in a local controller 150, or a memory system controller 140, or both. In some examples, one or more of a row decoder 220, a column decoder 225, and a sense component 245 may be co-located with or included in the local memory controller 260. The local memory controller 260 may be operable to receive commands or data from one or more different controllers (e.g., a host system controller 120, a memory system controller 140), translate the commands or the data into information that can be used by the architecture 200, initiate or control one or more operations of the architecture 200, and communicate data from the architecture 200 to a host (e.g., a host system 105) based on performing the one or more operations.

The local memory controller 260 may be operable to perform one or more access operations on one or more memory cells 205 of the architecture 200. Examples of an access operation may include a write operation, a read operation, a refresh operation, a precharge operation, or an activate operation, among others. In some examples, an access operation may be performed by or otherwise coordinated by the local memory controller 260 in response to one or more access commands (e.g., from a host system 105). The local memory controller 260 may be operable to perform other access operations not listed here or other operations related to the operating of the architecture 200 that are not directly related to accessing the memory cells 205.

In accordance with examples described herein, a memory system (e.g., that implements the architecture 200) and a host system may be configured to determine one or more causes of CRC errors based on a comparison of CRC values 270 associated with data 265, which may support the implementation of efficient and effect corrective actions. The host system may be configured to determine the cause of errors associated with writing the data 265 to the memory system. For example, the host system may transmit the data 265 and an associated CRC value 270 to the memory system. The memory system may store the data 265 and may calculate another CRC value 270 using the stored data 265. The memory system may compare the received CRC value 270 and the calculated CRC value 270 and, in the case that the two CRC values are not the same, may transmit an indication of a CRC error and the calculated CRC value 270 to the host system. The host system may utilize the CRC value 270 originally transmitted to the memory system and the calculated CRC value 270 received from the memory system to determine a cause of the error at a more granular level, such as occurring on an EDC channel or resulting from the transmission, storage, or retrieval of the data 265.

Additionally, or alternatively, the host system may be configured to determine the cause of errors associated with reading the data 265 from the memory system. For example, the memory system may calculate a CRC value 270 associated with data 265 requested by the host system and transmit the data 265 and the CRC value 270 to the host system. The host system may receive the data 265 and the CRC value 270 and may calculate another CRC value 270 using the received data 265. The host system may compare the CRC value 270 calculated from the received data 265 with the CRC value received from the memory system and an expected CRC value (e.g., a CRC value that may be associated with data the host system may expect from the memory system) to determine one or more causes of a CRC error.

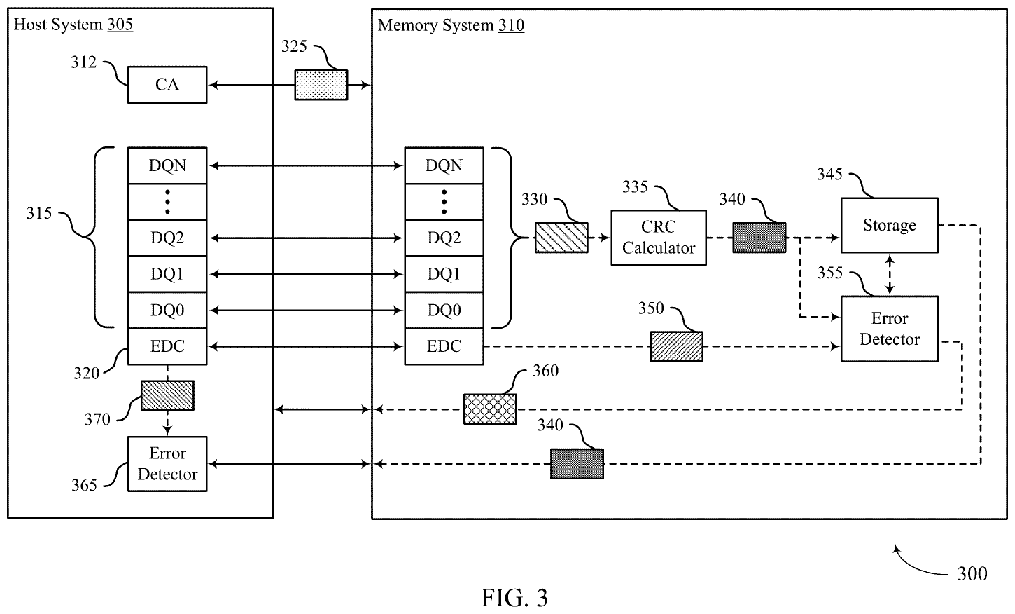

FIG. 3 shows an example of a system 300 that supports CRC comparison for error detection in accordance with examples as disclosed herein. The system 300 may be implemented by aspects of a system 100, an architecture 200, or one or more components thereof (e.g., a host system 105, a memory system 110, a local memory controller 260) as described with reference to FIGS. 1 and 2, respectively. The system 300 may support relatively more granular determination of CRC error causes associated with writing data to a memory system.

The system 300 may include a host system 305 and a memory system 310, which may be example of the corresponding systems described herein, including with reference to FIGS. 1 and 2. The host system 305 may communicate with the memory system 310 via one or more channels, such as a CA channel 312, one or more data channels 315 (e.g., one or more DQ channels), and an EDC channel 320 (e.g., a DQE channel), which may be examples of the channels described with reference to FIG. 1. Additionally, although non-limiting examples of the system 300 herein are generally described in terms of applicability to memory systems, memory sub-systems, memory devices, or a combination thereof, examples of the system 300 are not so limited. For example, aspects of the present disclosure may be applied as well to any computing system, computing sub-system, processing system, processing sub-system, component, device, structure, or other types of systems or sub-systems used for applications such as data collecting, data processing, data storage, networking, communication, power, artificial intelligence, system-on-a-chip, control, telemetry, sensing and monitoring, digital entertainment, or any combination thereof.

The host system 305 and the memory system 310 may include components to support improved error causation determination techniques. For example, the host system 305 may include an error detector 365 that may compare one or more CRC values to determine the cause of CRC errors. The memory system 310 may include a CRC calculator 335. The memory system 310 may input data 330 received from the host system 305 via the data channels 315 into the CRC calculator 335, and the CRC calculator 335 may generate (e.g., calculate) a calculated CRC value 340 associated with (e.g., based on) the data 330. In some examples, the calculated CRC value 340 (e.g., and one or more other CRC values) may be used to support error detection associated with the data 330 (e.g., resulting from the transmission of the data 330, storage of the data 330, retrieval of the stored data 330) or with communication of a CRC value associated with the data 330. For example, the memory system 310 may include an error detector 355 that may receive the calculated CRC value 340 and a CRC value 350 received from the host system 305 via the EDC channel 320 as inputs and may compare the calculated CRC value 340 to the received CRC value 350 to detect errors. In the case that the error detector 355 determine that the calculated CRC value 340 and the CRC value 350 may not match, the error detector 355 may indicate (e.g., output an indication of) a CRC error to the host system 305.

In accordance with examples described herein, the host system 305 may compare CRC values associated with the data 330 to determine where a detected error may have occurred as part of a write operation. For example, the host system 305 may transmit data (e.g., the data 330) and an associated CRC value (e.g., a CRC value 370 calculated using the data) to the memory system 310. The host system 305 may transmit the data via the data channels 315 (e.g., the DQ pins, the DQ channels) and may transmit the CRC value 370 via the EDC channel 320. The memory system 310 may receive the data and the CRC value. The data 330 may be the same as the data transmitted by the host system 305, such as if there is no error associated with the transmission of the data to the memory system 310 (e.g., and/or storage of the data to or retrieval of the data from a memory array of the memory system). The data 330 may be different from the data transmitted by the host system 305, such as if there is an error associated with the transmission (e.g., storage, and/or retrieval) of the data. Similarly, the CRC value 350 received from the host system 305 may be the same as the CRC value 370 transmitted by the host system, such as if there is no error associated with the transmission of the CRC value 370 via the EDC channel 320. Alternatively, the CRC value 350 may be different from the CRC value 370, such as if there is an error associated with the transmission of the CRC value 370 via the EDC channel 320. In some examples, the memory system 310 may store the data received from the host system 305 to a memory array of the memory system 310 (e.g., and temporarily store the received CRC value 350).

The memory system 310 may calculate a CRC value 340 based on the data 330 (e.g., which may correspond to the data received from the host system 305 or the data stored to and retrieved from the memory array of the memory system 310) and may compare the CRC value 340 to the CRC value 350. For example, the memory system 310 may input the data 330 into the CRC calculator 335. The CRC calculator 335 may utilize the data 330 to generate the CRC value 340. For example, the CRC calculator 335 may use a function that outputs the CRC value 340 using the data 330 as the input to the function. The memory system 310 may input the CRC value 340 and the CRC value 350 into the error detector 355, and the error detector 355 may compare the CRC value 340 to the CRC value 350. In the case that the CRC value 340 is not the same as (e.g., does not match) the CRC value 350, one or more errors may have occurred prior to the comparison of the CRC values 340 and 350, such as during transmission of the data via the data channels 315, during storage of the data 330 to the memory array of the memory system 310, during retrieval of the data from the memory array, during the transmission of the CRC value 370 via the EDC channel 320, or a combination thereof.

The host system 305 and the memory system 310 may support the determination of where the one or more errors occurred at a more granular level. For example, in response to detecting a CRC error (e.g., that the CRC values 340 and 350 are different), the memory system 310 (e.g., the error detector 355) may store the CRC value 340 to storage 345 of the memory system 310. In some examples, the storage 345 may be temporary storage of the memory system 310, a register of the memory system 310, a cache of the memory system 310, among other possible types of storage of the memory system 310. Additionally, the memory system 310 may indicate the error to the host system 305. For example, in response to detecting the error, the error detector 355 may transmit a CRC error flag 360 to the host system 305 indicating that the CRC values 340 and 350 are different (e.g., do not match). In some examples, if no CRC error is detected (e.g., the error detector 355 determines that the CRC values 340 and 350 are the same), no CRC error flag 360 is transmitted and the CRC value 340 may be discarded (e.g., the memory system 310 may refrain from storing the CRC value 340). In some other examples, the CRC value 340 may be initially stored to the storage 345 prior to the error determination by the error detector 355 and discarded (e.g., deleted from the storage 345) if no CRC error is detected.

The memory system 310 may transmit the CRC value 340 (e.g., the calculated CRC value) to the host system 305. For example, in response to receiving the CRC error flag 360, the host system 305 may transmit a command 325 to the memory system 310 via the CA channel 312. The command 325 may request that the memory system 310 transmit the CRC value 340 (e.g., the CRC value stored to the storage 345, the calculated CRC value) to the host system 305. The memory system 310 may receive the command 325 and may transmit the CRC value 340 to the error detector 365 of the host system 305 in response. For example, in response to receiving the command, the memory system 310 may read the CRC value 340 from the storage 345 and may transmit the CRC value 340 to the host system 305 (e.g., from the storage 345). Alternatively, the memory system 310 may transmit the CRC value 340 to the host system 305 in response to detecting the CRC error (e.g., determining that the CRC values 340 and 350 are different). For example, the memory system 310 may transmit the CRC value 340 to the host system 305 without receiving a command 325 in response to detecting the CRC error. In some examples, if the memory system 310 transmits the CRC value 340 in response to detecting the CRC error, the memory system 310 may refrain from storing the CRC value 340 to the storage 345.

In some examples, the memory system 310 (e.g., the error detector 355) may transmit the CRC value 340 to the host system 305 via one or more of the data channels 315. In some other examples, the memory system 310 may transmit the CRC value 340 to the host system 305 via the EDC channel 320 and may utilize an interface (e.g., a serial interface). The memory system 310 may transmit the CRC value 340 to the host system 305 at a rate that is slower than the rate of the data transmission from the host system 305 to the memory system 310, which may decrease the likelihood of errors associated with the transmission of the CRC value 340 to the host system 305. For example, the memory system 310 may transmit the CRC value 340 to the host system 305 at a first rate that is slower than a second rate at which the data is received from the host system 305 and/or slower than a third rate at which the CRC value 370 is transmitted by the host system 305.

The host system 305 may receive the CRC value 340 from the memory system 310 and may determine a type of the CRC error indicated by the CRC error flag 360 (e.g., a cause of the CRC error) based on whether the CRC value 340 is different than the CRC value originally transmitted to the memory system 310 (e.g., the CRC value 370). For example, the error detector 365 of the host system 305 may receive the CRC value 340 and may compare the CRC value 340 to the CRC value 370 (e.g., the CRC value originally transmitted to the memory system 310). In the case that the error detector 365 determines that the CRC value 340 is not the same as the CRC value 370, the host system 305 (e.g., the error detector 365) may determine that one or more errors may have occurred at least along a path of the data from the host system 305 to the CRC calculator 335, such as part of the transmission of the data from the host system 305 to the memory system 310 via the data channels 315, part of the storing of the data 330 to the memory array of the memory system 310, part of the retrieval of the data 330 from the memory array to the CRC calculator 335, or a combination thereof. For example, if the CRC values 340 and 370 are different, the respective data used to calculate the CRC values 340 and 370 are different. As such, the CRC values 340 and 370 being different may indicate one or more errors associated with the path of the data that includes the data channels 315, one or more circuits associated with storage of the data to the memory array, one or more circuits associated with reading the data from the memory array (e.g., column decoders 225, row decoders 220, input/output 255, sense components 245), or a combination thereof.

In the case that the error detector 365 determines that the CRC value 340 is not the same as the CRC value 370, another error may have occurred as part of (e.g., during) the transmission of the CRC value 370 from the host system 305 to the memory system 310 via the EDC channel 320. In some cases, it may be unclear as to whether such an error occurred, as it may be unknown whether the CRC values 350 and 370 are the same. However, the CRC values 340 and 370 being different may indicate that one or more errors occurred at least along the path of the data.

In some examples, if the host system 305 determines that the CRC values 340 and 370 are different, the host system 305 may determine which bits of the CRC value 340 are not the same as the bits of the CRC value 370, how many bits of the CRC value 340 are different, or both, to determine a location of an error along the path of the data. For example, the host system 305 may compare each bit of the received CRC value 340 to each bit of the CRC value 370 and may record the quantity and/or location of bits of the CRC value 340 that are different from the bits of the CRC value 370. The host system 305 may subsequently utilize the quantity and location of the bits to assist in determining where the error occurred. For example, if the same one or more bits of the CRC value 340 are always incorrect (e.g., different from the corresponding one or more bits of the CRC value 370) when transmitting the same data to the memory system 310 (e.g., multiple transmissions of the same data and subsequent transmissions of the same incorrect CRC value 340) and all the other bits of the CRC value 340 are correct, such a pattern of incorrect CRC bits may indicate a first location of the error along the path. Additionally, or alternatively, if all the bits of the CRC value 340 are incorrect, but always in the same way, such a pattern of incorrect CRC bits may indicate a second location of the error along the path. Additionally, or alternatively, if half of the bits of the CRC value 340 are incorrect, such a pattern of incorrect CRC bits may indicate a third location along the path (e.g., corresponding to a particular circuit used to store and/or retrieve the bits used to generate the incorrect half of bits).

Alternatively, the host system 305 may receive the CRC value 340 from the memory system 310 and may determine that the CRC value 340 is the same as the CRC value originally transmitted to the memory system 310 (e.g., the CRC value 370). For example, the error detector 365 of the host system 305 may receive the CRC value 340 and may compare the CRC value 340 to the CRC value 370 (e.g., the CRC value originally transmitted to the memory system 310). In the case that the error detector 365 may determine that the CRC value 340 is the same as the CRC value 370, the host system 305 (e.g., the error detector 365) may determine that the error may have occurred as part of (e.g., during) transmission of the CRC value 370 from the host system 305 to the memory system 310 via the EDC channel 320, and that the error may not have occurred along the path of the data 330. For example, if the CRC values 340 and 370 are the same, the respective data used to calculate the CRC values 340 and 370 are the same. Accordingly, there was no error that occurred along the path of the data from the host system 305 to the CRC calculator 335. Instead, the host system 305 may determine that the error is associated with the transmission of the CRC value 370 such that the CRC value 350 received by the memory system 310 is different from the CRC value 370.

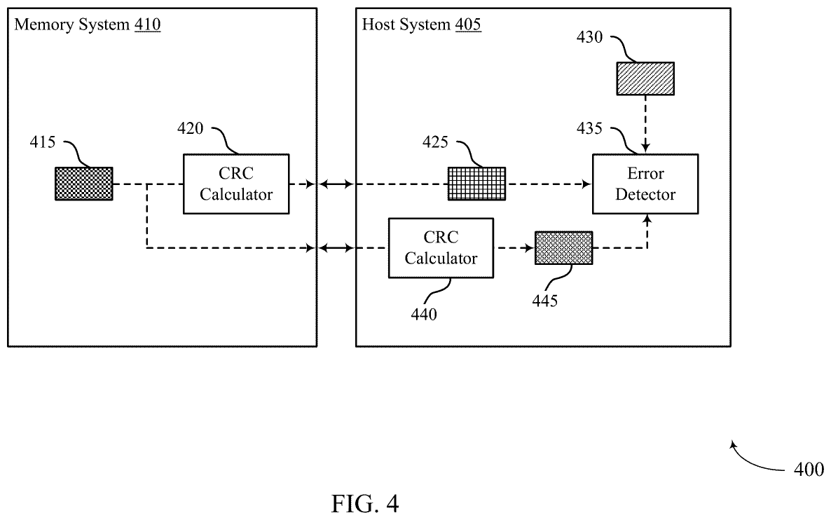

FIG. 4 shows an example of a system 400 that supports CRC comparison for error detection in accordance with examples as disclosed herein. The system 400 may be implemented by aspects of a system 100, an architecture 200, a system 300, or one or more components thereof (e.g., a host system 105, a memory system 110, a local memory controller 260, a memory system 310, and a host system 305) as described with reference to FIGS. 1-3, respectively. The system 400 may support relatively more granular determination of CRC error causes associated with reading data from a memory system.

In some examples, the system 400 may include a memory system 410, which may be an example of a memory system described herein, including with reference to FIGS. 1 and 3. The memory system 410 may include a CRC calculator 420. The memory system 410 may input data 415 into the CRC calculator 420, and the CRC calculator 420 may generate (e.g., calculate) a calculated CRC value 425 associated with (e.g., based on, using) the data 415. In some examples, the system 400 may include a host system 405, which may be an example of a host system described herein, including with reference to FIGS. 1-3. The host system 405 may include a CRC calculator 440. The host system 405 may input data received from the memory system 410 into the CRC calculator 440, and the CRC calculator 440 may generate (e.g., calculate) a calculated CRC value 445 associated with (e.g., based on, using) the data 415. The host system 405 may also include an error detector 435. The error detector 435 may compare various CRC values (e.g., the CRC value 425, the CRC value 445, an expected CRC value 430) to detect one or more errors and determine a cause of the one or more errors (e.g., a location of where the one or more errors may have occurred). Additionally, although non-limiting examples of the system 400 herein are generally described in terms of applicability to memory systems, memory sub-systems, memory devices, or a combination thereof, examples of the system 400 are not so limited. For example, aspects of the present disclosure may be applied as well to any computing system, computing sub-system, processing system, processing sub-system, component, device, structure, or other types of systems or sub-systems used for applications such as data collecting, data processing, data storage, networking, communication, power, artificial intelligence, system-on-a-chip, control, telemetry, sensing and monitoring, digital entertainment, or any combination thereof.

In accordance with examples described herein, the host system 405 may receive the CRC value 425 and may generate the CRC value 445 and the CRC value 430 to be utilized in determining where an error may have occurred as part of (e.g., during) a read operation. For example, the host system 405 may transmit a read command to the memory system 410 requesting the data 415. The memory system 410 may receive the read command and may retrieve the data 415 associated with the read command from a memory array of the memory system 410. The memory system 410 may input the data 415 into the CRC calculator 420, and the CRC calculator 420 may generate the CRC value 425. The memory system 410 may transmit the CRC value 425 (e.g., via an EDC channel) and the data 415 to the host system 405 (e.g., via one or more data channels). The host system 405 may receive the data 415 and the CRC value 425. The host system 405 may calculate a CRC value 445 based on (e.g., using) the received data 415. The host system 405 may generate (e.g., calculate) a CRC value 430 based on the data that the host system 405 expects to receive in response to transmitting the read command. As such, the CRC value 430 may be referred to as an expected CRC value 430.

The host system 405 may compare CRC values associated with the data 415 to determine whether an error associated with reading the data occurred and where a detected error may have occurred as part of the reading of the data. For example, the host system 405 may input the CRC value 425, the CRC value 430, and the CRC value 445 into the error detector 435 to determine if there may be an error and to determine a type of the error (e.g., determine where an error may have occurred). If the CRC values 425, 430 and 445 are the same, the host system 405 may determine that no error occurred.

In the case that the error detector 435 may determine, based on comparing the CRC values, that the CRC value 430 may not be the same as the CRC value 425 and the CRC value 445, while the CRC value 425 and the CRC value 445 may be the same, the host system 405 (e.g., the error detector 435) may determine that the error may have occurred on the path of the data 415 prior to the data 415 being input to the CRC calculator 420 (e.g., during retrieval of the data 415 from the memory array of the memory system 410). For example, the CRC values 425 and 445 being the same may indicate that that no error occurred as part of the transmission of the CRC values 425 and 445 via the EDC channel and data channels, respectively. However, because the CRC values 425 and 445 are not the same as the expected CRC value 430, the host system 405 may determine that an error occurred prior to the calculation of the CRC value 425 using the CRC calculator 420, such as part of the retrieval of the data 415 from the memory array (e.g., at one or more locations along a path of the data 415 from the memory array to the CRC calculator 420). Such an error may result in the data 415 being incorrect, thereby resulting in incorrect CRC values 425 and 445 that are calculated using the data 415.

In the case that the error detector 435 may determine (e.g., based on comparing the CRC values) that the CRC value 430 may be the same as the CRC value 425, while the CRC value 445 may not be the same as the CRC value 425 and the CRC value 430, the host system 405 may determine that the error may have occurred as part of (e.g., during) the transmission of the data 415 to the host system 405. For example, the CRC values 425 and 430 being the same may indicate that that no error occurred as part of the retrieval of the data 415 from the memory array, the calculation of the CRC value 425 using the data 415, and the transmission of the CRC value 425 via the EDC channel. However, because the CRC value 445 is not the same as the CRC values 425 and 430, the host system 405 may determine that an error occurred as part of the transmission of the data 415 via the one or more data channels. For example, such an error may result in incorrect data being input into the CRC calculator 440 at the host system 405, thereby resulting the CRC value 445 being incorrect.

In the case that the error detector 435 may determine (e.g., based on comparing the CRC values) that the CRC value 430 may be the same as the CRC value 445, while the CRC value 425 may not be the same as the CRC value 430 and the CRC value 445, the host system 405 may determine that the error may have occurred during transmission of the CRC value 425 from the memory system 410 to the host system 405 (e.g., via the EDC channel). For example, the CRC values 430 and 445 being the same may indicate that that no error occurred as part of the retrieval of the data 415 from the memory array and the transmission of the data 415 via the one or more data channels, as the data 415 received at the host system 405 and used to calculate the CRC value 445 results in the correct CRC value (e.g., a CRC value that matches the expected CRC value 430). However, because the CRC value 425 is not the same as the CRC values 430 and 445, the host system 405 may determine that an error occurred as part of the transmission of the CRC value 425 via the EDC channel such that the CRC value 425 is incorrect.

In the case that the error detector 435 may determine (e.g., based on comparing the CRC values) that the CRC value 430, the CRC value 425, and the CRC value 445 are each different from each other (e.g., may not be the same), the host system 405 may determine that two or more errors (e.g., at least two errors) may have occurred as part of reading the data, such as: part of transmission of the CRC value 425 from the memory system 410 to the host system 405; on the path of the data 415 prior to the data 415 being input to the CRC calculator 420 (e.g., during retrieval of the data 415 from the memory array of the memory system 410 to the CRC calculator 420); part of the transmission of the data 415 to the host system 405, or a combination thereof.

By determining the origin of an error, the host system 405 may be enabled to take more efficient and corrective actions to reduce the likelihood of (e.g., avoid) errors in the future.

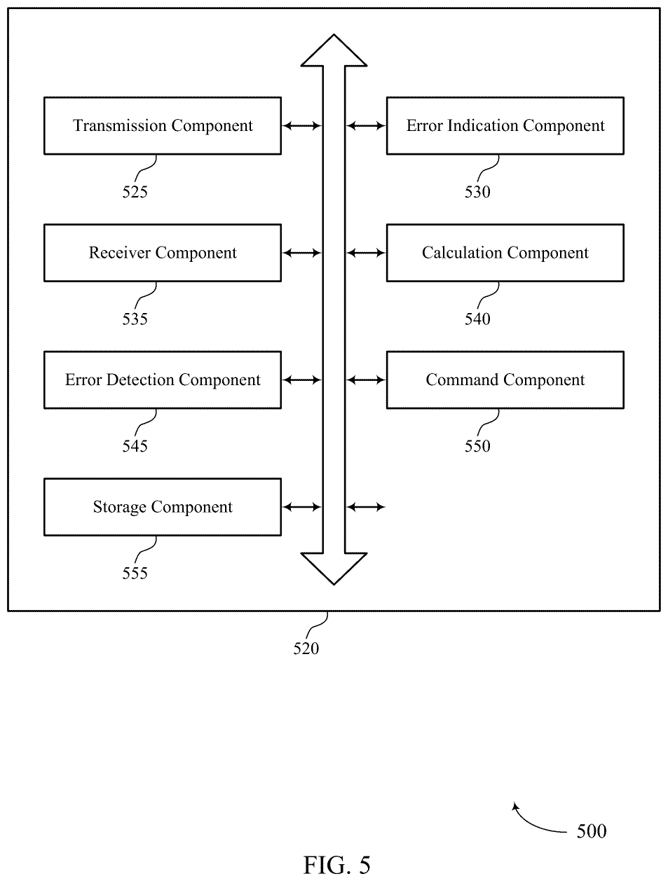

FIG. 5 shows a block diagram 500 of a host system 520 that supports CRC comparison for error detection in accordance with examples as disclosed herein. The host system 520 may be an example of aspects of a host system as described with reference to FIGS. 1 through 4. The host system 520, or various components thereof, may be an example of means for performing various aspects of CRC comparison for error detection as described herein. For example, the host system 520 may include a transmission component 525, an error indication component 530, a receiver component 535, a calculation component 540, an error detection component 545, a command component 550, a storage component 555, or any combination thereof. Each of these components, or components of subcomponents thereof (e.g., one or more processors, one or more memories), may communicate, directly or indirectly, with one another (e.g., via one or more buses).

The transmission component 525 may be configured as or otherwise support a means for transmitting data via a set of data channels and a first indication of a first CRC value corresponding to the data via an error detection channel. The error indication component 530 may be configured as or otherwise support a means for receiving a second indication of an error associated with the first CRC value. The receiver component 535 may be configured as or otherwise support a means for receiving a third indication of a second CRC value corresponding to the data based at least in part on receiving the second indication of the error.

In some examples, the error detection component 545 may be configured as or otherwise support a means for determining a type of the error based at least in part on a comparison of the first CRC value to the second CRC value.

In some examples, to support determining the type of error, the error detection component 545 may be configured as or otherwise support a means for determining, based at least in part on the first CRC value being different than the second CRC value, the error is at least associated with a path of the data including the set of data channels, one or more circuits associated with storage of the data to memory cells of the memory array, one or more circuits associated with reading the data from the memory cells, or a combination thereof.

In some examples, to support determining the type of error, the error detection component 545 may be configured as or otherwise support a means for determining a location of the error along the path of the data based at least in part on determining which bits of the first CRC value are different than corresponding bits of the second CRC value.

In some examples, to support determining the type of error, the error detection component 545 may be configured as or otherwise support a means for determining the error is associated with communication of the first indication of the first CRC value via the error detection channel based at least in part on the first CRC value being the same as the second CRC value.

In some examples, the command component 550 may be configured as or otherwise support a means for transmitting, based at least in part on receiving the second indication of the error, a command to transmit the third indication of the second CRC value, where the third indication is received based at least in part on the command.

In some examples, to support receiving the third indication of the second CRC value, the receiver component 535 may be configured as or otherwise support a means for receiving the third indication of the second CRC value via the error detection channel, where the third indication of the second CRC value is received at a first rate that is slower than a second rate at which the first indication of the first CRC value is transmitted.

In some examples, to support receiving the third indication of the second CRC value, the receiver component 535 may be configured as or otherwise support a means for receiving the third indication of the second CRC value via the set of data channels, where the third indication of the second CRC value is received at a first rate that is slower than a second rate at which the first indication of the first CRC value is transmitted.

Additionally, or alternatively, the command component 550 may be configured as or otherwise support a means for transmitting, to a memory system, a command to read data from the memory system. In some examples, the receiver component 535 may be configured as or otherwise support a means for receiving the data via a set of data channels and a first indication of a first CRC value associated with the data via an error detection channel. The calculation component 540 may be configured as or otherwise support a means for calculating, based at least in part on the data, a second CRC value. The error detection component 545 may be configured as or otherwise support a means for determining an error type associated with the data based at least in part on a comparison of the first CRC value, the second CRC value, and an expected CRC value associated with the data.

In some examples, to support determining the error type, the error detection component 545 may be configured as or otherwise support a means for determining, based at least in part on the first CRC value and the second CRC value being the same and the expected CRC value being different than the first CRC value and the second CRC value, an error associated with the data prior to a calculation of the first CRC value at the memory system using the data.

In some examples, to support determining the error type, the error detection component 545 may be configured as or otherwise support a means for determining an error is associated with communication of the data via the set of data channels based at least in part on the first CRC value and the expected CRC value being the same and the second CRC value being different than the first CRC value and the expected CRC value.

In some examples, to support determining the error type, the error detection component 545 may be configured as or otherwise support a means for determining an error associated with communication of the first indication of the first CRC value via the error detection channel based at least in part on the second CRC value and the expected CRC value being the same and the first CRC value being different than the second CRC value and the expected CRC value.

In some examples, to support determining the error type, the error detection component 545 may be configured as or otherwise support a means for determining, based at least in part on each of the first CRC value, the second CRC value, and the expected CRC value being different, at least two errors, each of the at least two errors associated with the data prior to a calculation of the first CRC value at the memory system, associated with communication of the data via the set of data channels, or associated with communication of the first indication of the first CRC value via the error detection channel.

In some examples, the storage component 555 may be configured as or otherwise support a means for storing a table of a set of error types, where determining the error type includes reading an entry of the table corresponding to the error type in accordance with one or more differences between the first CRC value, the second CRC value, the expected CRC value, or a combination thereof.

In some examples, the calculation component 540 may be configured as or otherwise support a means for calculating the expected CRC value based at least in part on expected data associated with the command.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

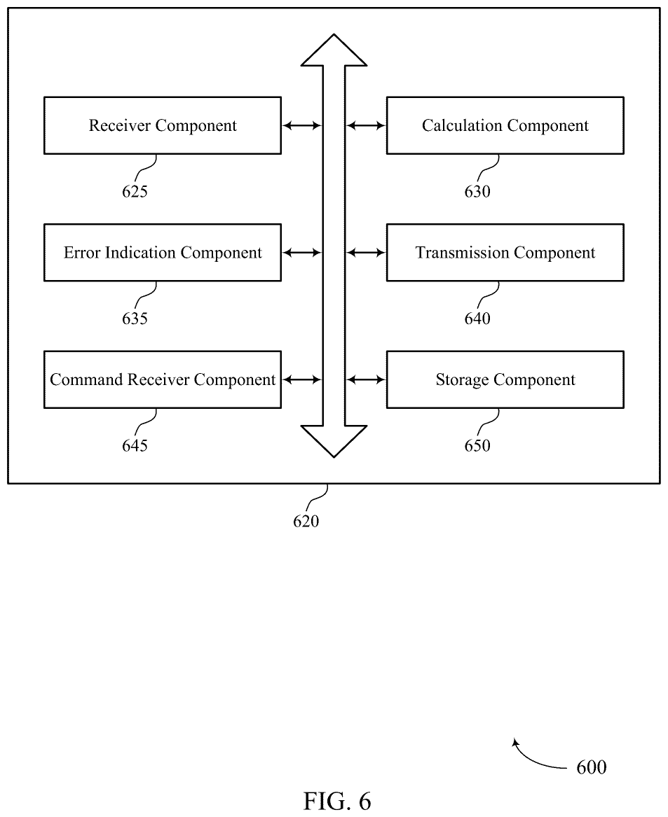

FIG. 6 shows a block diagram 600 of a memory system 620 that supports CRC comparison for error detection in accordance with examples as disclosed herein. The memory system 620 may be an example of aspects of a memory system as described with reference to FIGS. 1 through 4. The memory system 620, or various components thereof, may be an example of means for performing various aspects of CRC comparison for error detection as described herein. For example, the memory system 620 may include a receiver component 625, a calculation component 630, an error indication component 635, a transmission component 640, a command component 645, a storage component 650, or any combination thereof. Each of these components, or components of subcomponents thereof (e.g., one or more processors, one or more memories), may communicate, directly or indirectly, with one another (e.g., via one or more buses).

The receiver component 625 may be configured as or otherwise support a means for receiving data via a set of data channels and a first indication of a first CRC value corresponding to the data via an error detection channel. The calculation component 630 may be configured as or otherwise support a means for calculating, based at least in part on the data, a second CRC value. The error indication component 635 may be configured as or otherwise support a means for transmitting a second indication of an error based at least in part on the first CRC value being different than the second CRC value. The transmission component 640 may be configured as or otherwise support a means for transmitting a third indication of the second CRC value based at least in part on transmitting the second indication of the error.

In some examples, the command component 645 may be configured as or otherwise support a means for receiving, based at least in part on transmitting the second indication of the error, a command to transmit the third indication of the second CRC value, where the third indication is transmitted based at least in part on the command.

In some examples, to support transmitting the third indication of the second CRC value, the transmission component 640 may be configured as or otherwise support a means for transmitting the third indication of the second CRC value via the error detection channel, where the third indication of the second CRC value is transmitted at a first rate that is slower than a second rate at which the first indication of the first CRC value is received.

In some examples, to support transmitting the third indication of the second CRC value, the transmission component 640 may be configured as or otherwise support a means for transmitting the third indication of the second CRC value via the set of data channels, where the third indication of the second CRC value is transmitted at a first rate that is slower than a second rate at which the first indication of the first CRC value is received.

In some examples, the storage component 650 may be configured as or otherwise support a means for storing the second CRC value based at least in part on the first CRC value being different than the second CRC value, where the third indication of the second CRC value is transmitted based at least in part on the storing.

In some examples, the receiver component 625 may be configured as or otherwise support a means for receiving second data via the set of data channels and a fourth indication of a third CRC value corresponding to the second data via the error detection channel. In some examples, the calculation component 630 may be configured as or otherwise support a means for calculating, based at least in part on the second data, a fourth CRC value. In some examples, the storage component 650 may be configured as or otherwise support a means for refraining from storing the fourth CRC value based at least in part on the third CRC value and the fourth CRC value being the same.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

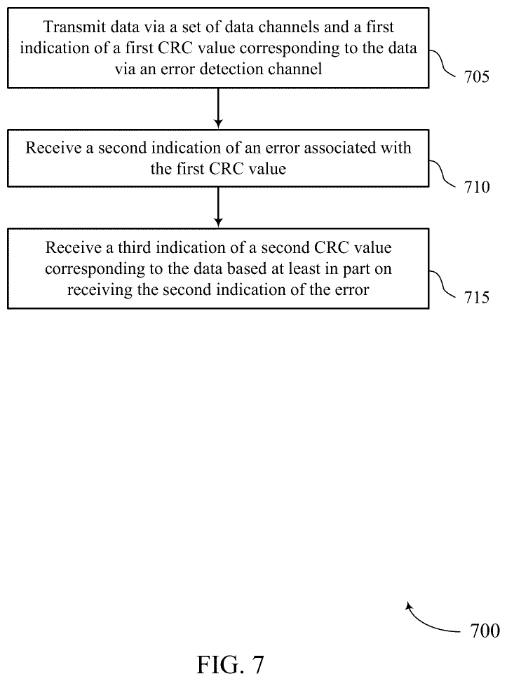

FIG. 7 shows a flowchart illustrating a method 700 that supports CRC comparison for error detection in accordance with examples as disclosed herein. The operations of method 700 may be implemented by a host system or its components as described herein. For example, the operations of method 700 may be performed by a host system as described with reference to FIGS. 1 through 5. In some examples, a host system may execute a set of instructions to control the functional elements of the device to perform the described functions. Additionally, or alternatively, the host system may perform aspects of the described functions using special-purpose hardware.

At 705, the method may include transmitting data via a set of data channels and a first indication of a first CRC value corresponding to the data via an error detection channel. In some examples, aspects of the operations of 705 may be performed by a transmission component 525 as described with reference to FIG. 5.

At 710, the method may include receiving a second indication of an error associated with the first CRC value. In some examples, aspects of the operations of 710 may be performed by an error indication component 530 as described with reference to FIG. 5.

At 715, the method may include receiving a third indication of a second CRC value corresponding to the data based at least in part on receiving the second indication of the error. In some examples, aspects of the operations of 715 may be performed by a receiver component 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting data via a set of data channels and a first indication of a first CRC value corresponding to the data via an error detection channel; receiving a second indication of an error associated with the first CRC value; and receiving a third indication of a second CRC value corresponding to the data based at least in part on receiving the second indication of the error.

Aspect 2: The method, apparatus, or non-transitory computer-readable medium of aspect 1, further including operations, features, circuitry, logic, means, or instructions, or any combination thereof for determining a type of the error based at least in part on a comparison of the first CRC value to the second CRC value.

Aspect 3: The method, apparatus, or non-transitory computer-readable medium of aspect 2, where determining the type of error includes operations, features, circuitry, logic, means, or instructions, or any combination thereof for determining, based at least in part on the first CRC value being different than the second CRC value, the error is at least associated with a path of the data including the set of data channels, one or more circuits associated with storage of the data to memory cells of the memory array, one or more circuits associated with reading the data from the memory cells, or a combination thereof.

Aspect 4: The method, apparatus, or non-transitory computer-readable medium of aspect 3, where determining the type of error includes operations, features, circuitry, logic, means, or instructions, or any combination thereof for determining a location of the error along the path of the data based at least in part on determining which bits of the first CRC value are different than corresponding bits of the second CRC value.

Aspect 5: The method, apparatus, or non-transitory computer-readable medium of aspect 2, where determining the type of error includes operations, features, circuitry, logic, means, or instructions, or any combination thereof for determining the error is associated with communication of the first indication of the first CRC value via the error detection channel based at least in part on the first CRC value being the same as the second CRC value.

Aspect 6: The method, apparatus, or non-transitory computer-readable medium of any of aspects 1 through 5, further including operations, features, circuitry, logic, means, or instructions, or any combination thereof for transmitting, based at least in part on receiving the second indication of the error, a command to transmit the third indication of the second CRC value, where the third indication is received based at least in part on the command.

Aspect 7: The method, apparatus, or non-transitory computer-readable medium of any of aspects 1 through 6, where receiving the third indication of the second CRC value includes operations, features, circuitry, logic, means, or instructions, or any combination thereof for receiving the third indication of the second CRC value via the error detection channel, where the third indication of the second CRC value is received at a first rate that is slower than a second rate at which the first indication of the first CRC value is transmitted.

Aspect 8: The method, apparatus, or non-transitory computer-readable medium of any of aspects 1 through 6, where receiving the third indication of the second CRC value includes operations, features, circuitry, logic, means, or instructions, or any combination thereof for receiving the third indication of the second CRC value via the set of data channels, where the third indication of the second CRC value is received at a first rate that is slower than a second rate at which the first indication of the first CRC value is transmitted.

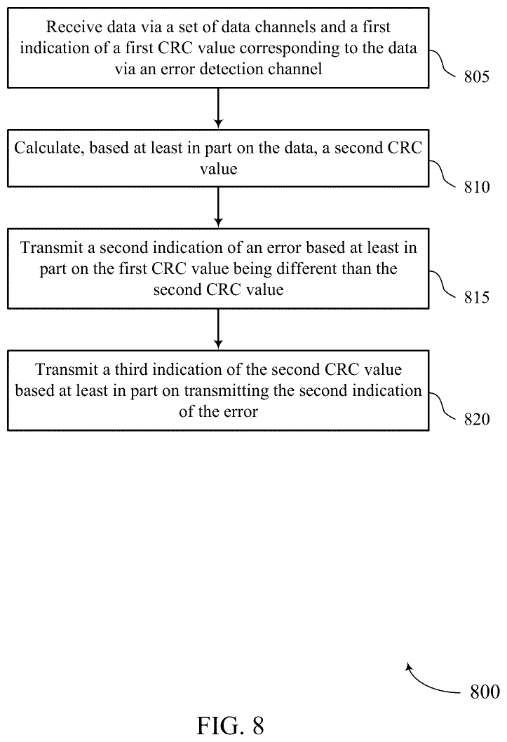

FIG. 8 shows a flowchart illustrating a method 800 that supports CRC comparison for error detection in accordance with examples as disclosed herein. The operations of method 800 may be implemented by a memory system or its components as described herein. For example, the operations of method 800 may be performed by a memory system as described with reference to FIGS. 1 through 4 and 6. In some examples, a memory system may execute a set of instructions to control the functional elements of the device to perform the described functions. Additionally, or alternatively, the memory system may perform aspects of the described functions using special-purpose hardware.

At 805, the method may include receiving data via a set of data channels and a first indication of a first CRC value corresponding to the data via an error detection channel. In some examples, aspects of the operations of 805 may be performed by a receiver component 625 as described with reference to FIG. 6.

At 810, the method may include calculating, based at least in part on the data, a second CRC value. In some examples, aspects of the operations of 810 may be performed by a calculation component 630 as described with reference to FIG. 6.

At 815, the method may include transmitting a second indication of an error based at least in part on the first CRC value being different than the second CRC value. In some examples, aspects of the operations of 815 may be performed by an error indication component 635 as described with reference to FIG. 6.

At 820, the method may include transmitting a third indication of the second CRC value based at least in part on transmitting the second indication of the error. In some examples, aspects of the operations of 820 may be performed by a transmission component 640 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for receiving data via a set of data channels and a first indication of a first CRC value corresponding to the data via an error detection channel; calculating, based at least in part on the data, a second CRC value; transmitting a second indication of an error based at least in part on the first CRC value being different than the second CRC value; and transmitting a third indication of the second CRC value based at least in part on transmitting the second indication of the error.

Aspect 10: The method, apparatus, or non-transitory computer-readable medium of aspect 9, further including operations, features, circuitry, logic, means, or instructions, or any combination thereof for receiving, based at least in part on transmitting the second indication of the error, a command to transmit the third indication of the second CRC value, where the third indication is transmitted based at least in part on the command.

Aspect 11: The method, apparatus, or non-transitory computer-readable medium of any of aspects 9 through 10, where transmitting the third indication of the second CRC value includes operations, features, circuitry, logic, means, or instructions, or any combination thereof for transmitting the third indication of the second CRC value via the error detection channel, where the third indication of the second CRC value is transmitted at a first rate that is slower than a second rate at which the first indication of the first CRC value is received.

Aspect 12: The method, apparatus, or non-transitory computer-readable medium of any of aspects 9 through 10, where transmitting the third indication of the second CRC value includes operations, features, circuitry, logic, means, or instructions, or any combination thereof for transmitting the third indication of the second CRC value via the set of data channels, where the third indication of the second CRC value is transmitted at a first rate that is slower than a second rate at which the first indication of the first CRC value is received.

Aspect 13: The method, apparatus, or non-transitory computer-readable medium of any of aspects 9 through 12, further including operations, features, circuitry, logic, means, or instructions, or any combination thereof for storing the second CRC value based at least in part on the first CRC value being different than the second CRC value, where the third indication of the second CRC value is transmitted based at least in part on the storing.

Aspect 14: The method, apparatus, or non-transitory computer-readable medium of any of aspects 9 through 13, further including operations, features, circuitry, logic, means, or instructions, or any combination thereof for receiving second data via the set of data channels and a fourth indication of a third CRC value corresponding to the second data via the error detection channel; calculating, based at least in part on the second data, a fourth CRC value; and refraining from storing the fourth CRC value based at least in part on the third CRC value and the fourth CRC value being the same.

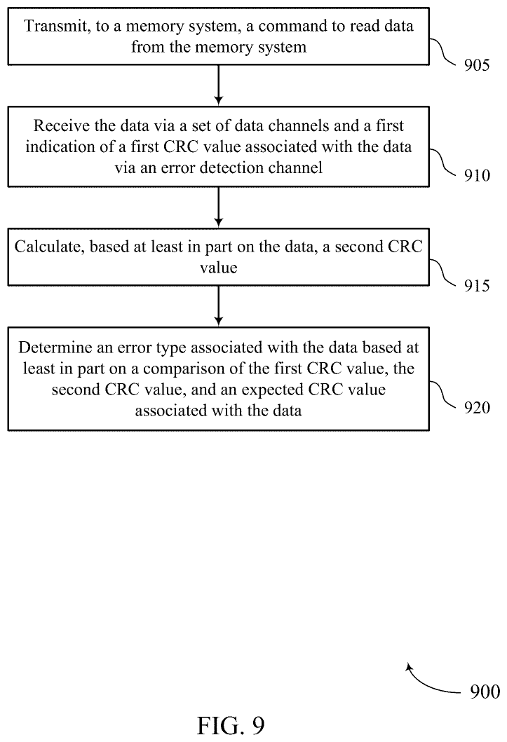

FIG. 9 shows a flowchart illustrating a method 900 that supports CRC comparison for error detection in accordance with examples as disclosed herein. The operations of method 900 may be implemented by a host system or its components as described herein. For example, the operations of method 900 may be performed by a host system as described with reference to FIGS. 1 through 5. In some examples, a host system may execute a set of instructions to control the functional elements of the device to perform the described functions. Additionally, or alternatively, the host system may perform aspects of the described functions using special-purpose hardware.

At 905, the method may include transmitting, to a memory system, a command to read data from the memory system. In some examples, aspects of the operations of 905 may be performed by a transmission component 525 as described with reference to FIG. 5.

At 910, the method may include receiving the data via a set of data channels and a first indication of a first CRC value associated with the data via an error detection channel. In some examples, aspects of the operations of 910 may be performed by a receiver component 535 as described with reference to FIG. 5.

At 915, the method may include calculating, based at least in part on the data, a second CRC value. In some examples, aspects of the operations of 915 may be performed by a calculation component 540 as described with reference to FIG. 5.

At 920, the method may include determining an error type associated with the data based at least in part on a comparison of the first CRC value, the second CRC value, and an expected CRC value associated with the data. In some examples, aspects of the operations of 920 may be performed by an error detection component 545 as described with reference to FIG. 5.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 15: A method, apparatus, or non-transitory computer-readable medium including operations, features, circuitry, logic, means, or instructions, or any combination thereof for transmitting, to a memory system, a command to read data from the memory system; receiving the data via a set of data channels and a first indication of a first CRC value associated with the data via an error detection channel; calculating, based at least in part on the data, a second CRC value; and determining an error type associated with the data based at least in part on a comparison of the first CRC value, the second CRC value, and an expected CRC value associated with the data.

Aspect 16: The method, apparatus, or non-transitory computer-readable medium of aspect 15, where determining the error type includes operations, features, circuitry, logic, means, or instructions, or any combination thereof for determining, based at least in part on the first CRC value and the second CRC value being the same and the expected CRC value being different than the first CRC value and the second CRC value, an error associated with the data prior to a calculation of the first CRC value at the memory system using the data.

Aspect 17: The method, apparatus, or non-transitory computer-readable medium of aspect 15, where determining the error type includes operations, features, circuitry, logic, means, or instructions, or any combination thereof for determining an error is associated with communication of the data via the set of data channels based at least in part on the first CRC value and the expected CRC value being the same and the second CRC value being different than the first CRC value and the expected CRC value.

Aspect 18: The method, apparatus, or non-transitory computer-readable medium of aspect 15, where determining the error type includes operations, features, circuitry, logic, means, or instructions, or any combination thereof for determining an error associated with communication of the first indication of the first CRC value via the error detection channel based at least in part on the second CRC value and the expected CRC value being the same and the first CRC value being different than the second CRC value and the expected CRC value.

Aspect 19: The method, apparatus, or non-transitory computer-readable medium of aspect 15, where determining the error type includes operations, features, circuitry, logic, means, or instructions, or any combination thereof for determining, based at least in part on each of the first CRC value, the second CRC value, and the expected CRC value being different, at least two errors, each of the at least two errors associated with the data prior to a calculation of the first CRC value at the memory system, associated with communication of the data via the set of data channels, or associated with communication of the first indication of the first CRC value via the error detection channel.

Aspect 20: The method, apparatus, or non-transitory computer-readable medium of any of aspects 15 through 19, further including operations, features, circuitry, logic, means, or instructions, or any combination thereof for storing a table of a set of error types, where determining the error type includes reading an entry of the table corresponding to the error type in accordance with one or more differences between the first CRC value, the second CRC value, the expected CRC value, or a combination thereof.

Aspect 21: The method, apparatus, or non-transitory computer-readable medium of any of aspects 15 through 20, further including operations, features, circuitry, logic, means, or instructions, or any combination thereof for calculating the expected CRC value based at least in part on expected data associated with the command.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processor. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, that can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or a processor.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
transmitting data via a set of data channels and a first indication of a first cyclic redundancy check (CRC) value corresponding to the data via an error detection channel;
receiving a second indication of an error associated with the first CRC value; and
receiving a third indication of a second CRC value corresponding to the data based at least in part on receiving the second indication of the error.

2. The method of claim 1, further comprising:
determining a type of the error based at least in part on a comparison of the first CRC value to the second CRC value.

3. The method of claim 2, wherein determining the type of error comprises:
determining, based at least in part on the first CRC value being different than the second CRC value, the error is at least associated with a path of the data comprising the set of data channels, one or more circuits associated with storage of the data to memory cells of a memory array, one or more circuits associated with reading the data from the memory cells, or a combination thereof.

4. The method of claim 3, wherein determining the type of error comprises:
determining a location of the error along the path of the data based at least in part on determining which bits of the first CRC value are different than corresponding bits of the second CRC value.

5. The method of claim 2, wherein determining the type of error comprises:
determining the error is associated with communication of the first indication of the first CRC value via the error detection channel based at least in part on the first CRC value being a same as the second CRC value.

6. The method of claim 1, further comprising:
transmitting, based at least in part on receiving the second indication of the error, a command to transmit the third indication of the second CRC value, wherein the third indication is received based at least in part on the command.

7. The method of claim 1, wherein receiving the third indication of the second CRC value comprises:
receiving the third indication of the second CRC value via the error detection channel, wherein the third indication of the second CRC value is received at a first rate that is slower than a second rate at which the first indication of the first CRC value is transmitted.

8. The method of claim 1, wherein receiving the third indication of the second CRC value comprises:
receiving the third indication of the second CRC value via the set of data channels, wherein the third indication of the second CRC value is received at a first rate that is slower than a second rate at which the first indication of the first CRC value is transmitted.

9. A method, comprising:
receiving data via a set of data channels and a first indication of a first cyclic redundancy check (CRC) value corresponding to the data via an error detection channel;
calculating, based at least in part on the data, a second CRC value;
transmitting a second indication of an error based at least in part on the first CRC value being different than the second CRC value; and
transmitting a third indication of the second CRC value based at least in part on transmitting the second indication of the error.

10. The method of claim 9, further comprising:
receiving, based at least in part on transmitting the second indication of the error, a command to transmit the third indication of the second CRC value, wherein the third indication is transmitted based at least in part on the command.

11. The method of claim 10, wherein transmitting the third indication of the second CRC value comprises:
transmitting the third indication of the second CRC value via the error detection channel, wherein the third indication of the second CRC value is transmitted at a first rate that is slower than a second rate at which the first indication of the first CRC value is received.

12. The method of claim 10, wherein transmitting the third indication of the second CRC value comprises:
transmitting the third indication of the second CRC value via the set of data channels, wherein the third indication of the second CRC value is transmitted at a first rate that is slower than a second rate at which the first indication of the first CRC value is received.

13. The method of claim 9, further comprising:
storing the second CRC value based at least in part on the first CRC value being different than the second CRC value, wherein the third indication of the second CRC value is transmitted based at least in part on the storing.

14. The method of claim 9, further comprising:
receiving second data via the set of data channels and a fourth indication of a third CRC value corresponding to the second data via the error detection channel;
calculating, based at least in part on the second data, a fourth CRC value; and
refraining from storing the fourth CRC value based at least in part on the third CRC value and the fourth CRC value being a same value.

15. A method, comprising:
transmitting, to a memory system, a command to read data from the memory system;
receiving the data via a set of data channels and a first indication of a first cyclic redundancy check (CRC) value associated with the data via an error detection channel;
calculating, based at least in part on the data, a second CRC value; and
determining an error type associated with the data based at least in part on a comparison of the first CRC value, the second CRC value, and an expected CRC value associated with the data.

16. The method of claim 15, wherein determining the error type comprises:
determining, based at least in part on the first CRC value and the second CRC value being a same value and the expected CRC value being different than the first CRC value and the second CRC value, an error associated with the data prior to a calculation of the first CRC value at the memory system using the data.

17. The method of claim 15, wherein determining the error type comprises:
determining an error is associated with communication of the data via the set of data channels based at least in part on the first CRC value and the expected CRC value being a same value and the second CRC value being different than the first CRC value and the expected CRC value.

18. The method of claim 15, wherein determining the error type comprises:
determining an error associated with communication of the first indication of the first CRC value via the error detection channel based at least in part on the second CRC value and the expected CRC value being a same value and the first CRC value being different than the second CRC value and the expected CRC value.

19. The method of claim 15, wherein determining the error type comprises:
determining, based at least in part on each of the first CRC value, the second CRC value, and the expected CRC value being different, at least two errors, each of the at least two errors associated with the data prior to a calculation of the first CRC value at the memory system, associated with communication of the data via the set of data channels, or associated with communication of the first indication of the first CRC value via the error detection channel.

20. The method of claim 15, further comprising:
storing a table of a set of error types, wherein determining the error type comprises reading an entry of the table corresponding to the error type in accordance with one or more differences between the first CRC value, the second CRC value, the expected CRC value, or a combination thereof.
